(19) United States
(12) Patent Application Publication
(10) Pub. No.: US 2024/0178427 A1
(43) Pub. Date: May 30, 2024

(54) SOLID OXIDE CELL

(71) Applicant: SAMSUNG ELECTRO-MECHANICS CO., LTD., Suwon-si (KR)

(72) Inventors: Jaeseok YI, Suwon-si (KR); Jung Deok PARK, Suwon-si (KR); Hong Ryul LEE, Suwon-si (KR); Jae Hyuk JANG, Suwon-si (KR)

(73) Assignee: SAMSUNG ELECTRO-MECHANICS CO., LTD., Suwon-si (KR)

(21) Appl. No.: 18/226,973

(22) Filed: Jul. 27, 2023

(30) Foreign Application Priority Data
Nov. 30, 2022 (KR) 10-2022-0164769
Dec. 30, 2022 (KR) 10-2022-0190974

(51) Int. Cl. H01M 8/1213; H01M 8/12

(52) U.S. Cl. CPC H01M 8/1213; H01M 8/12; H01M 2008/1293

(57) ABSTRACT

A solid oxide cell includes a fuel electrode, an air electrode, and an electrolyte disposed between the fuel electrode and the air electrode and including a plurality of rods. At least one of the fuel electrode or the air electrode is disposed along surfaces of the plurality of rods.

### CROSS-REFERENCE TO RELATED APPLICATION (S)

This application claims benefit of priority to Korean Patent Application No. 10-2022-0190974 filed on Dec. 30, 2022 and Korean Patent Application No. 10-2022-0164769 filed on Nov. 30, 2022 in the Korean Intellectual Property Office, the disclosures of which are incorporated herein by reference in their entirety.

### TECHNICAL FIELD

The present disclosure relates to a solid oxide cell.

### BACKGROUND

A solid oxide fuel cell (SOFC) and a solid oxide electrolysis cell (SOEC) include a cell composed of an air electrode, a fuel electrode, and a solid electrolyte having oxygen ion conductivity, in which case, the cell may be referred to as a solid oxide cell. The solid oxide cell produces electrical energy through an electrochemical reaction or electrolyzes water through the reverse reaction of a solid oxide fuel cell to produce hydrogen. Solid oxide cells have low overvoltage based on the low activation polarization, and low irreversible loss, compared to other types of fuel cells or water electrolysis cells, such as phosphoric acid fuel cells (PAFC), alkali fuel cells (AFC), polymer electrolyte membrane fuel cells (PEMFC), direct methanol fuel cells (DMFC), or the like, thereby providing high efficiency. In addition, the solid oxide cell may be used as carbon or hydrocarbon-based fuel as well as hydrogen, and thus, there is a wide range of fuel choices. Since the reaction rate at the electrode is high, the solid oxide cell has the advantage of not requiring expensive precious metals as an electrode catalyst.

A solid oxide cell generally has a structure in which an electrolyte is disposed between electrode layers (e.g., an air electrode and a fuel electrode), and a reaction to function as a battery occurs in the electrode layer. In order for the reaction to occur effectively in the electrode layer, gas should be able to pass in and out easily, and to this end, a technique of forming an electrode layer as a porous body and the like is known.

### SUMMARY

An aspect of the present disclosure is to implement a highly reactive solid oxide cell by providing smooth gas flow.

According to an aspect of the present disclosure, a novel structure of a solid oxide cell is proposed through an example. The solid oxide cell includes a fuel electrode, an air electrode, and an electrolyte disposed between the fuel electrode and the air electrode and including a plurality of rods (or columns). At least one of the fuel electrode or the air electrode is disposed along surfaces of the plurality of rods.

The plurality of rods may be regularly arranged in columns and rows.

The plurality of rods may include at least one rod having an aspect ratio of 2 or more.

The electrolyte may include a base layer having a first surface and a second surface positioned on respective sides of the fuel electrode and the air electrode, and the plurality of rods may be disposed on at least one of the first surface or the second surface of the base layer.

The plurality of rods may be disposed on the first surface of the base layer, and the fuel electrode may be disposed along surfaces of the base layer and the plurality of rods.

A surface of the fuel electrode may have an irregular shape.

The fuel electrode may not substantially include an ion conductor.

The plurality of rods may be disposed on the second surface of the base layer, and the air electrode may be formed along surfaces of the base layer and the plurality of rods.

A surface of the air electrode may have an irregular shape.

The air electrode may not substantially include an ion conductor.

The base layer may be a ceramic sintered body, and the plurality of rods may have a single crystal structure.

The base layer and the plurality of rods may be ceramic sintered bodies.

The plurality of rods may include a rod having a shape of at least one of a cylinder or a triangular prism.

The plurality of rods may include a rod having a tube shape.

The plurality of rods may include a rod having a plurality of protrusions formed on the surface.

According to another aspect of the present disclosure, a solid oxide cell includes a fuel electrode, an air electrode, and an electrolyte disposed between the fuel electrode and the air electrode and including a plurality of rods having an aspect ratio of 2 or more.

According to still another aspect of the present disclosure, a solid oxide cell includes an electrolyte including a base layer having a first surface and a second surface opposing each other and a plurality of columns protruding from at least one of the first surface or the second surface of the base layer, a fuel electrode, and an air electrode. The electrolyte is disposed between the fuel electrode and the air electrode.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic cross-sectional view of a solid oxide cell according to an embodiment;

FIG. 2 is a perspective view illustrating an electrolyte that may be employed in the solid oxide cell of FIG. 1;

FIGS. 3 and 4 are cross-sectional views schematically illustrating a solid oxide cell according to a modified example;

FIGS. 5 and 6 are enlarged views of one region of the solid oxide cell;

FIG. 7 illustrates an example of a method of forming a rod structure of an electrolyte;

FIG. 8 illustrates another example of a method of forming a rod structure of an electrolyte; and

FIGS. 9, 10, 11A, 11B, and 11C illustrate examples of shapes that may be used as the rod structure of the electrolyte.

### DETAILED DESCRIPTION

Hereinafter, embodiments will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

To clearly describe the present disclosure in the drawings, parts irrelevant to the description are omitted, and to clearly express the various layers and regions, the thickness is enlarged and illustrated, and elements having the same function within the scope of the same concept are described using the same reference numerals. Furthermore, throughout the specification, when a certain component is said to “include,” it means that it may further include other components without excluding other components unless otherwise stated.

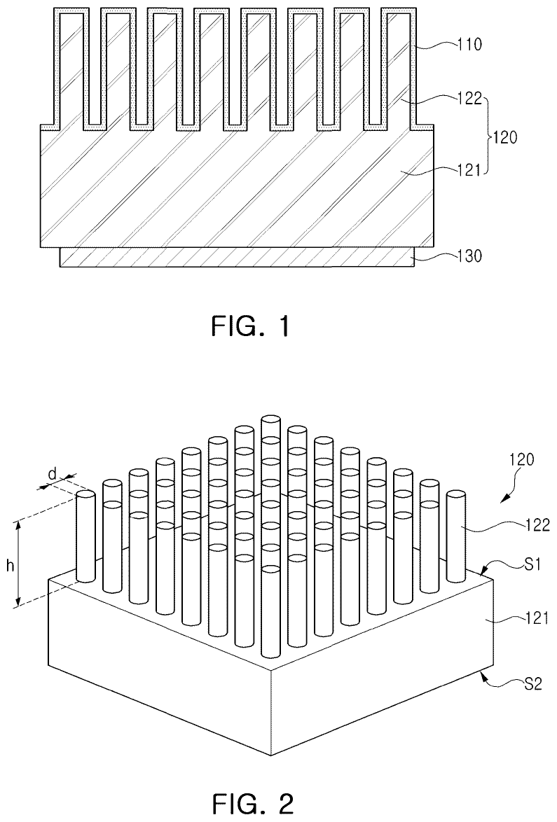

FIG. 1 is a schematic cross-sectional view of a solid oxide cell according to an embodiment. FIG. 2 is a perspective view illustrating an electrolyte that may be employed in the solid oxide cell of FIG. 1.

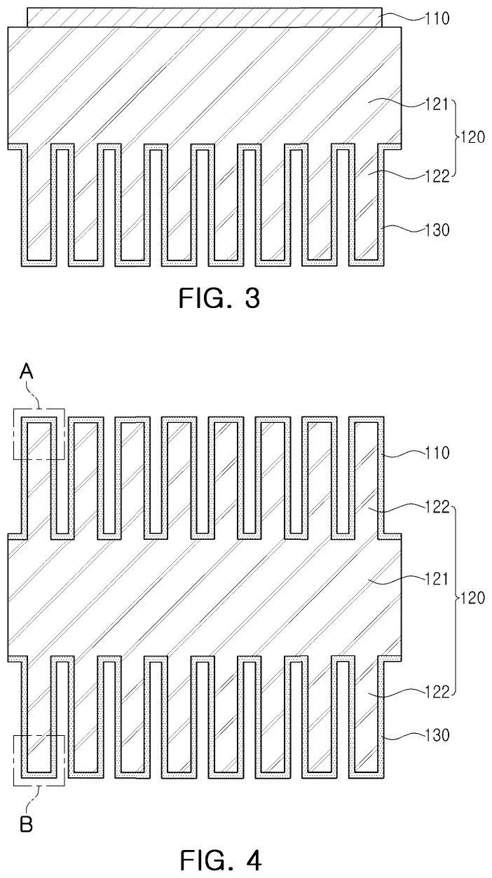

Referring to FIGS. 1 and 2, a solid oxide cell 100 according to an embodiment includes a fuel electrode 110, an air electrode 130, and an electrolyte 120 disposed therebetween and including a plurality of rods (or columns) 122, as main components. At least one of the fuel electrode 110 or the air electrode 130 is formed along the surface of the plurality of rods 122, and FIG. 1 illustrates an example in which the fuel electrode 110 is formed along the surface of the plurality of rods 122. However, as in the modified example of FIG. 3, the air electrode 130 may be formed along the surface of the plurality of rods 122, and also, as in the modified example of FIG. 4, both the fuel electrode 110 and the air electrode 130 may be formed along the surfaces of the plurality of rods 122.

The plurality of rods 122 provided in the electrolyte 120 function as passages through which gas may easily enter and exit, thereby improving reactivity within the solid oxide cell 100. In addition, since the size and shape of the pores may be effectively controlled through the structure of the rod 122 of the electrolyte 120, unlike the porous electrode used in a conventional cell structure in which pores are randomly formed, the reactivity may be further improved. These advantages may significantly contribute to improving the characteristics of the solid oxide cell 100. Hereinafter, components of the solid oxide cell 100 will be described in detail, and a case in which the solid oxide cell 100 is used as a fuel cell will be mainly described. However, the solid oxide cell 100 may also be used as a water electrolytic cell, and in this case, a reaction opposite to the reaction of a fuel cell will occur in the fuel electrode 110 and the air electrode 130 of the solid oxide cell 100.

In detail, when the solid oxide cell 100 is a fuel cell, for example, in the fuel electrode 110, water generation due to oxidation of hydrogen or an oxidation reaction of carbon compounds may occur, and in the air electrode 130, an oxygen ion generation reaction may occur due to decomposition of oxygen. When the solid oxide cell 100 is a water electrolytic cell, the opposite reaction may occur. For example, hydrogen gas may be generated according to a reduction reaction of water in the fuel electrode 110, and oxygen may be generated in the air electrode 130. As another example, in the case of a fuel cell, hydrogen decomposition (hydrogen ion generation) reaction may occur in the fuel electrode 110, and oxygen and hydrogen ions are combined in the air electrode 130 to generate water, and in the case of a water electrolytic cell, decomposition of water (generation of hydrogen and oxygen ions) occurs in the fuel electrode 110, and oxygen may be generated in the air electrode 130. In the electrolyte 120, ions may move to the fuel electrode 110 or the air electrode 130.

In the case of the present embodiment, as described above, the fuel electrode 110 is formed along the surface of the plurality of rods 122 of the electrolyte 120, and as will be described later, the fuel electrode 110 is formed of a metal body containing an electron conductor, such as Ni, and may be substantially free of ionic conductors. This is because the plurality of rods 122 of the electrolyte 120 may function as ion conductors.

In describing materials constituting the fuel electrode 110, the electrolyte 120, and the air electrode 130 in detail, first, the fuel electrode 110 may include an electron conductor and an ion conductor. In this case, the fuel electrode 110 may include a cermet layer that includes a metal-containing phase and a ceramic phase, which may correspond to electron conductors and ion conductors, respectively. In this case, the metal-containing phase may include a metal catalyst such as nickel (Ni), cobalt (Co), copper (Cu), alloys thereof, or the like, which acts as an electron conductor. The metal catalyst may be in a metallic state or may be in an oxide state. In the case of the ceramic phase of the fuel electrode 110, gadolinia doped ceria (GDC), Samaria doped ceria (SDC), ytterbia doped ceria (YDC), scandia stabilized zirconia (SSZ), ytterbia ceria scandia stabilized zirconia (YbCSSZ) and the like may be included. On the other hand, as described above, when the fuel electrode 110 is formed along the surface of the plurality of rods 122, for example, by following the surface, as illustrated in FIGS. 1 and 4, the fuel electrode 110 may not substantially contain ion conductors. Alternatively, in the case in which the fuel electrode 110 has a flat plate structure as illustrated in FIG. 3, the fuel electrode 110 may be formed of a porous body including an electron conductor and an ion conductor.

The electrolyte 120 is disposed between the fuel electrode 110 and the air electrode 130. As an example of a material constituting the electrolyte 120, the electrolyte 120 may include stabilized zirconia. In detail, the electrolyte 120 may include scandia stabilized zirconia (SSZ), yttria stabilized zirconia (YSZ), scandia ceria stabilized zirconia (SCSZ), scandia ceria yttria stabilized zirconia (SCYSZ), scandia ceria ytterbia stabilized zirconia (SCYbSZ), etc.

The air electrode 130 may include an electronically conductive material, such as, for example, an electronically conductive perovskite material such as lanthanum strontium manganite (LSM). Other conducting perovskites, for example, metals such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or Pt may also be used. In some embodiments, the air electrode 130 may include a mixture of an electron conductor and an ion conductor (e.g., an ion conductive ceramic material). For example, the air electrode 130 may include about 10 wt % to about 90 wt % of an electrically conductive material (e.g., LSM, etc.) and about 10 wt % to about 90 wt % of an ion conductive material. In this case, the ion conductive material may further include zirconia-based (e.g., YSZ) and/or ceria-based materials. As illustrated in FIGS. 3 and 4, when the air electrode 130 is formed along the surface of the plurality of rods 122, for example, by following the surface, the air electrode 130 may not substantially include an ion conductor. Alternatively, in the case in which the air electrode 130 has a flat plate structure as illustrated in FIG. 1, the air electrode 130 may be formed of a porous body including an electron conductor and an ion conductor.

Describing the structure of the rod 122 of the electrolyte 120 in more detail, the plurality of rods 122 may be a structure having a height (h) that is longer than the diameter (d) of the bottom surface. In this case, the plurality of rods 122 may include rods having an aspect ratio of 2 or more. The diameter (d) of the rod 122 may refer to a diameter equivalent to a circle when the bottom surface is not circular, and may also be an average value of a maximum diameter and a diameter in a direction perpendicular thereto.

As illustrated in FIG. 2, the plurality of rods 122 may be regularly arranged in columns and rows. By regularly disposing the plurality of rods 122, the flow of gas may be smoothed and the reaction area may be expanded within the fuel electrode 110, and furthermore, the reaction area may be uniformly disposed throughout the solid oxide cell 100. Accordingly, the electrical conduction path, the ion conduction path, and the gas flow path may be controlled uniformly rather than randomly, and the effective area of the effective reaction region, for example, the three phase boundary of the electron conductor, the ion conductor, and the gas may be increased.

The electrolyte 120 includes a base layer 121 having a first surface S1 and a second surface S2 respectively positioned on the fuel electrode 110 and air electrode 130 sides, and in this case, the plurality of rods 122 may be disposed on at least one of the first surface S1 or the second surface S2 of the base layer 121. In this case, as in the embodiment of FIG. 2, the plurality of rods 122 are disposed on the first surface S1 of the base layer 121, and the fuel electrode 110 may be formed along the surface of the base layer 121 and the plurality of rods 122. In addition, as in the embodiment of FIG. 3, the plurality of rods 122 may be disposed on the second surface S2 of the base layer 121, and the air electrode 130 may be formed along the surface of the base layer 121 and the plurality of rods 122. In addition, as in the embodiment of FIG. 4, the plurality of rods 122 are disposed both on the first surface S1 and the second surface S2 of the base layer 121, and the fuel electrode 110 and the air electrode 130 may be formed along the surface of the base layer 121 and the plurality of rods 122.

On the other hand, in the case in which the plurality of rods 122 include rods having an aspect ratio of 2 or more to sufficiently provide gas flow passages and reaction regions, the electrode layers 110 and 130 do not necessarily have to be formed along the surfaces thereof. For example, when the electrolyte 120 includes a plurality of rods 122 having an aspect ratio of 2 or more, it is sufficient that the fuel electrode 110 or the air electrode 130 is in contact with at least a portion of the electrolyte 120, and it will not necessarily be formed along the surface of the plurality of rods 122.

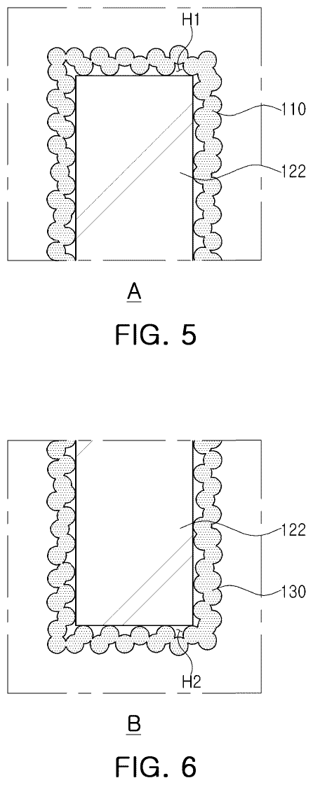

The fuel electrode 110 may be formed by a method of applying a paste to the surfaces of the plurality of rods 122 and then sintering the same, a method of depositing or sputtering the material of the fuel electrode 110 on the surfaces of the plurality of rods 122, or the like. When the fuel electrode 110 is formed along the surface of the plurality of rods 122, as can be seen in the enlarged view of FIG. 5, the surface of the fuel electrode 110 may have an irregular shape, and a plurality of pores H1 may be provided therein. Similarly, the air electrode 130 may be formed by a method of applying a paste to the surface of the plurality of rods 122 and then sintering the same, a method of depositing or sputtering the material of the air electrode 130 on the surface of the plurality of rods 122, or the like. When the air electrode 130 is formed along the surface of the plurality of rods 122, as can be seen in the enlarged view of FIG. 6, the surface of the air electrode 130 may include an irregular shape, and a plurality of pores H2 may be provided therein. In one embodiment, some portions of the fuel electrode 110 or the air electrode 130 may not be in contact with the corresponding surface of the plurality of rods 122 because of the pores H1 or H2.

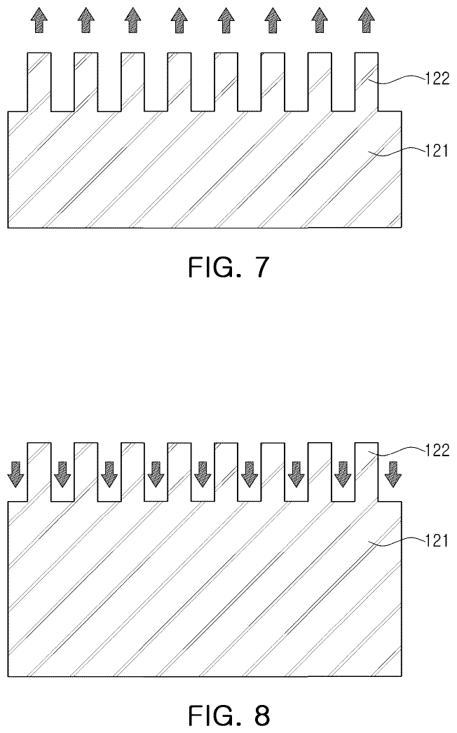

The rod 122 of the electrolyte 120 may be grown on the surface of the base layer 121 as in the form illustrated in FIG. 7. In this case, the plurality of rods 122 may be formed using a deposition process, as a detailed example, metal-organic chemical vapor deposition (MOCVD). When formed through such a deposition process, the base layer 121 and the plurality of rods 122 may have different organizational structures. For example, the plurality of rods 122 may have a single crystal structure, and unlike this, the base layer 121 may be a ceramic sintered body. Also, as illustrated in FIG. 8, the plurality of rods 122 may be formed by etching the base layer 121. In this case, the etching process of the base layer 121 may be, for example, reactive ion etching (RIE), plasma etching, chemical etching, or the like. In this manner, when the plurality of rods 122 are formed through the etching process, the base layer 121 and the plurality of rods 122 may have the same organizational structure. In detail, the base layer 121 and the plurality of rods 122 may be a ceramic sintered body.

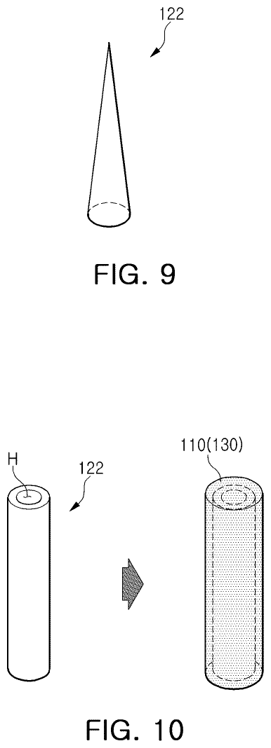

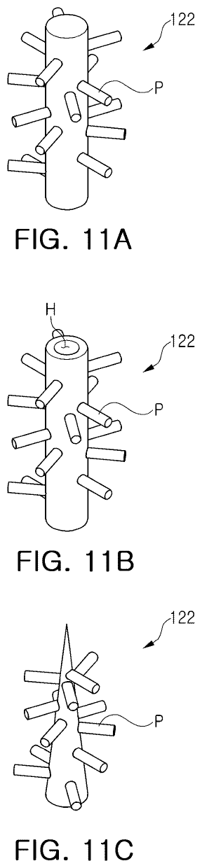

As described above, the electrolyte 120 may provide a passage suitable for gas flow by having the plurality of rods 122, and furthermore, may provide a wide and uniform reflection area with electrode layers 110 and 130 connected to the plurality of rods 122. In the case of these plurality of rods 122, the shape may be variously modified as long as the rod structure is maintained. First, as illustrated in FIG. 2, the plurality of rods 122 may include rods having a cylindrical or similar cylindrical shape, and in this case, the cylindrical shape may include cases where the shape or diameter of the bottom and upper surfaces are slightly different. In addition to the cylindrical shape, a rod 122 in the form of a triangular prism as illustrated in FIG. 9 may also be used. Still further, the rod 122 may have a tube shape as illustrated in FIG. 10. For example, the rod 122 may include a through-hole H penetrating in the thickness direction. When the rod 122 is implemented in a tube shape in this manner, a gas flow path and a reaction area may be further increased. In this case, as illustrated on the right side of FIG. 10, the electrode layers 110 and 130 may also be formed in the hole H of the tubular rod 122. Next, as illustrated in FIG. 11A, the plurality of rods 122 may include a rod having a plurality of protrusions P formed on the surface thereof, and the reactivity of the electrode layers 110 and 130 may be further improved through these protrusions P. The protrusions P may also be applied to a rod of a tube structure as illustrated in FIG. 11B and a rod of a triangular prism shape as illustrated in FIG. 11C.

As set forth above, according to an example, a solid oxide cell having a smooth gas flow and thus having excellent reactivity may be provided. Therefore, performance may be improved when the solid oxide cell is used as a fuel cell or water electrolysis cell.

While example embodiments have been illustrated and described above, it will be apparent to those skilled in the art that modifications and variations could be made without departing from the scope of the present invention as defined by the appended claims.

What is claimed is:

1. A solid oxide cell comprising:
a fuel electrode;
an air electrode; and
an electrolyte disposed between the fuel electrode and the air electrode and including a plurality of rods,
wherein at least one of the fuel electrode or the air electrode is disposed along surfaces of the plurality of rods.

2. The solid oxide cell of claim 1, wherein the plurality of rods are regularly arranged in columns and rows.

3. The solid oxide cell of claim 1, wherein the plurality of rods include at least one rod having an aspect ratio of 2 or more.

4. The solid oxide cell of claim 1, wherein the electrolyte includes a base layer having a first surface and a second surface positioned on respective sides of the fuel electrode and the air electrode, and the plurality of rods are disposed on at least one of the first surface or the second surface of the base layer.

5. The solid oxide cell of claim 4, wherein the plurality of rods are disposed on the first surface of the base layer, and the fuel electrode is disposed along surfaces of the base layer and the plurality of rods.

6. The solid oxide cell of claim 5, wherein a surface of the fuel electrode has an irregular shape.

7. The solid oxide cell of claim 5, wherein the fuel electrode does not include an ion conductor.

8. The solid oxide cell of claim 4, wherein the plurality of rods are disposed on the second surface of the base layer, and the air electrode is disposed along surfaces of the base layer and the plurality of rods.

9. The solid oxide cell of claim 8, wherein a surface of the air electrode has an irregular shape.

10. The solid oxide cell of claim 8, wherein the air electrode does not include an ion conductor.

11. The solid oxide cell of claim 4, wherein the base layer is a ceramic sintered body, and the plurality of rods have a single crystal structure.

12. The solid oxide cell of claim 4, wherein the base layer and the plurality of rods are ceramic sintered bodies.

13. The solid oxide cell of claim 1, wherein the plurality of rods include a rod having a shape of at least one of a cylinder or a triangular prism.

14. The solid oxide cell of claim 1, wherein the plurality of rods include a rod having a tube shape.

15. The solid oxide cell of claim 1, wherein the plurality of rods include a rod having a plurality of protrusions formed on a surface of the rod.

16. A solid oxide cell comprising:
a fuel electrode;
an air electrode; and
an electrolyte disposed between the fuel electrode and the air electrode and including a plurality of rods having an aspect ratio of 2 or more.

17. The solid oxide cell of claim 16, wherein the plurality of rods are regularly arranged in columns and rows.

18. A solid oxide cell comprising:
an electrolyte including a base layer having a first surface and a second surface opposing each other, the electrolyte further including a plurality of columns protruding from at least one of the first surface or the second surface of the base layer;
a fuel electrode; and
an air electrode,
wherein the electrolyte is disposed between the fuel electrode and the air electrode.

19. The solid oxide cell of claim 18, wherein the plurality of columns include at least one column having an aspect ratio of 2 or more.

20. The solid oxide cell of claim 18, wherein each of the plurality of columns is in a form of a cylindrical shape, a triangular prism, or a tube shape including a through-hole.
